(19) United States
(12) Patent Application Publication
(10) Pub. No.: US 2026/0230883 A1
(43) Pub. Date: Aug. 6, 2026

(54) HANDLING OF MULTIPLE ANALYTICS REPORTS BY A NETWORK NODE

(71) Applicant: Telefonaktiebolaget LM Ericsson (publ), Stockholm (SE)

(72) Inventors: Athanasios KARAPANTELAKIS, SOLNA (SE); Lackis ELEFTHERIADIS, Valbo (SE); Danesh DAROUI, Gothenburg (SE); Oleg GORBATOV, Luleå (SE); Attila MITCSENKOV, Budapest (HU); Ulf MATTSSON, KUNGSBACKA (SE); Antonio INIESTA GONZALEZ, Madrid (ES)

(21) Appl. No.: 19/149,737

(22) PCT Filed: Jul. 13, 2023
(86) PCT No.: PCT/EP2023/069520

§ 371 Date: Jul. 21, 2025

(30) Foreign Application Priority Data
Jan. 23, 2023 (GR) 20230100048

(51) Int. Cl. H04W 24/10

(52) U.S. Cl. CPC H04W 24/10

(57) ABSTRACT

According to an aspect, there is provided a method performed by a network node (10; 14) in a communication network. The method comprises generating (501), using a first trained model, respective analytics reports for a plurality of requests received from a plurality of network function, NF, consumers (12). Each generated analytics report comprises an indication of an action that the respective NF consumer is predicted to take in response to evaluating the respective analytics report. The method further comprises determining (502) one of the requests to prioritise; and sending (503) the generated analytics report corresponding to the prioritised request to the NF consumer that the prioritised request was received from.

### TECHNICAL FIELD

This disclosure relates to analytics reports generated by a network node (e.g. a network function) for a plurality of network function (NF) consumers, and in particular to techniques for handling the delivery of the analytics reports by the network node.

### BACKGROUND

The Network Data and Analytics Function (NWDAF) in the 5th Generation (5G) core (5GC) is a Network Function (NF) that is designed to generate statistics and predictions for analytic reports, in response to requests from service consumers (e.g., other NFs). The NWDAF can be configured to generate different types of analytics report, and a service consumer can request a particular type of analytics report, according to its needs. To provide an analytics report, the NWDAF may use machine learning (ML) models to evaluate data collected from the network, as described in the 3rd Generation Partnership Project (3GPP) Technical Standard (TS) 23.288 v17.4.0 “Architecture enhancements for 5G System (5GS) to support network data analytics services” (referred to herein as “Reference 1”). 3GPP TS 28.552 v18.1.0 (2022-12) “Management and orchestration; 5G performance measurements” provides details of the statistics and other content of analytics reports. Some types of analytics report that can be generated include: reports relating to congestion levels in the network; reports predicting quality of experience (QoE) metrics; reports predicting mobility patterns; reports predicting or indicating slice load; etc. The NWDAF may include a confidence measure in the report relating to the prediction. This confidence measure can indicate the confidence the NWDAF has in the prediction (or report as a whole) being accurate.

The recipient of the analytics report may take an action in response to the analytics report. For example, a Policy Control Function (PCF) may request the NWDAF to predict potential future congestion. If the NWDAF predicts that there will be a congestion, the PCF can perform remedies such as preventive actions to avoid the congestion.

### SUMMARY

It is proposed that when generating the analytic reports, the ML model used by the NWDAF (or a separate ML model) may predict an action that is to be taken by the NF consumer in response to receiving and evaluating the analytics report. The report itself may indicate the predicted action. The taking of this action by the NF consumer may have an effect on the operation and/or performance of the communication network. Typical types of action that can be taken include: traffic engineering decisions (e.g. routing and/or configuration changes); priority settings; resource assignments and limitations; service adaptation and admission control; etc.

The NWDAF can receive multiple requests for analytics reports from different NF consumers in a similar time period, and the resulting analytics reports (e.g. generated based on the same or similar data) may include respective predictions of actions to be taken by the NF consumers. It is possible that multiple ones of or all of these actions may conflict with each other, or be redundant. For example, multiple NF consumers may perform the same action, but only one of them needed to do so to achieve the desired effect on the communication network. Instead, multiple NF consumers performing the action can misuse or waste network resources (since not all NF consumers needed to take the action). In addition, the effect of the multiple instances of the action can ‘overdo’ the indended effect, leading to corrective actions needing to be performed by one or more NF consumers (further wasting network resources). In the case where different actions are predicted for different NF consumers, these actions can conflict with each other, meaning that the actions may act contrary to each other (e.g. one action can increase a parameter, and another action can decrease the parameter). This action conflict can lead to further actions being predicted/required in order to achieve the desired effect, further wasting network resources in making those parameter changes.

For example, consider a scenario where a Network Slice Instance (NSI) load level KPI (i.e. a key performance indicator, relating to the use of a slice of the network) is monitored. The NWDAF can predict future values of this KPI, and two different NF consumers request this type of prediction in the form of an analytics report, e.g. an Access and mobility Managemenet Function (AMF) and a Network Slice Selection Function (NSSF). The NWDAF predicts that for a slice with identifier K (which can be referred to as a network slice instance identifier, NSI ID) there will be congestion, meaning that KPI will exceed a threshold (e.g. 99%) in the next 10 minutes. Based on this prediction, NSSF can update the Network Slice Selection Assistance Information (NSSAI) to a new NSI ID, which is less congested that the current one. The AMF on the other hand can take an action to handover some UE to another nearby cell using a handover request. However, as NSI ID for the UE has been changed, the AMF, uninformed about the change, will take an action to reject UEs registering for the new NSI ID.

Therefore there is a need for techniques that improve the handling of multiple analytics reports by a network node (e.g. a NWDAF).

According to a first aspect, there is provided a method performed by a network node in a communication network. The method comprises generating, using a first trained model, respective analytics reports for a plurality of requests received from a plurality of network function, NF, consumers, wherein each generated analytics report comprises an indication of an action that the respective NF consumer is predicted to take in response to evaluating the respective analytics report; selecting one of the requests; and sending the generated analytics report corresponding to the selected request to the NF consumer that the selected request was received from.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided a network node for use in a communication network. The network node is configured to generate, using a first trained model, respective analytics reports for a plurality of requests received from a plurality of network function, NF, consumers, wherein each generated analytics report comprises an indication of an action that the respective NF consumer is predicted to take in response to evaluating the respective analytics report; select one of the requests; and send the generated analytics report corresponding to the selected request to the NF consumer that the selected request was received from.

According to a fourth aspect, there is provided a network node for use in a communication network. The network node comprises a processor and a memory, said memory containing instructions executable by said processor whereby said network node is operative to generate, using a first trained model, respective analytics reports for a plurality of requests received from a plurality of network function, NF, consumers, wherein each generated analytics report comprises an indication of an action that the respective NF consumer is predicted to take in response to evaluating the respective analytics report; select one of the requests; and send the generated analytics report corresponding to the selected request to the NF consumer that the selected request was received from.

Thus, the techniques described herein enable conflicts between actions by different NF consumers to be avoided, and avoid the taking of redundant actions.

### BRIEF DESCRIPTION OF THE DRAWINGS

Some of the embodiments contemplated herein will now be described more fully with reference to the accompanying drawings, in which:

FIG. 1 is a simplified block diagram of part of communication network;

FIG. 2 is a signalling diagram illustrating an embodiment of handling the delivery of analytics reports in response to multiple analytics requests;

FIG. 3 is a signalling diagram illustrating an embodiment of training a ML model to predict actions to be performed by a NF consumer in response to an analytics report;

FIG. 4 is a signalling diagram illustrating an embodiment for assessing the accuracy of a ML model;

FIG. 5 is a flow chart illustrating a method of operating a network node according to some embodiments;

FIG. 6 is a block diagram of a network node in accordance with some embodiments; and

FIG. 7 is a block diagram illustrating a virtualization environment in which functions implemented by some embodiments may be virtualized.

### DETAILED DESCRIPTION

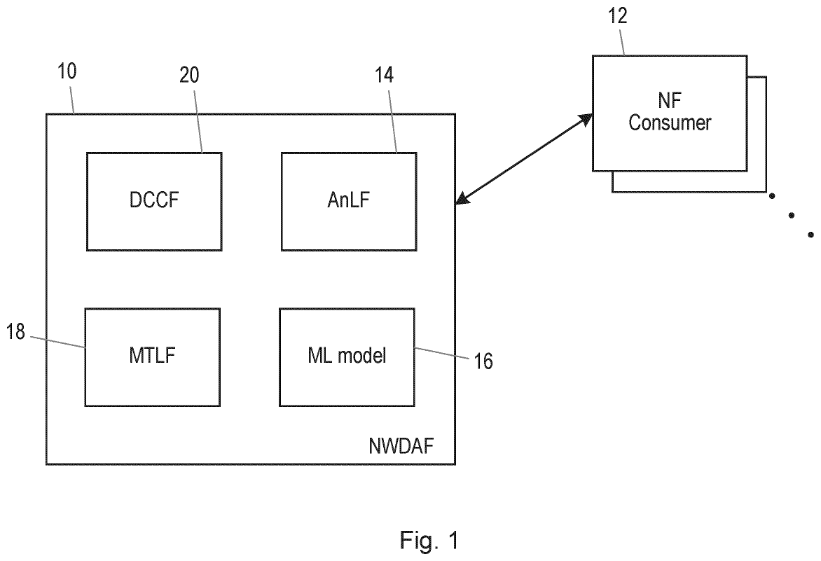

FIG. 1 is a block diagram showing a part of a communication network in which the techniques described herein can be used. The communication network comprises a network node 10 that is to provide analytics reports to one or more NF consumers 12 in the communication network in response to requests for analytics reports. In the illustrated embodiment, network node 10 is a NWDAF 10, but the network node 10 can be any other type of analytics node that is capable of generating analytics reports from data relating to the communication network.

A communication network can comprise a number of different types of NF consumer, and one or more instances of those NF consumers. In the 5GC, types of NF consumer 12 can include a Network Slice Selection Function (NSSF), a Network Exposure Function (NEF), a Network Repository Function (NRF), a Policy Control Function (PCF), a Unified Data Management (UDM), an Application Function (AF), an Authentication Server Function (AUSF), an Access and Mobility Management Function (AMF), and a Session Management Function (SMF).

In FIG. 1, some of the functions of the NWDAF 10 are indicated by respective functional blocks, with these functional blocks comprising an Analytics Logical Function (AnLF) 14 which is a part of the NWDAF 10 that is responsible for generating reports or analytics (‘data analytics reports’) using a machine learning (ML) model 16. The NWDAF 10 is also shown as including a Model Training Logical Function (MTLF) 18 that is responsible for providing and/or training the ML models for use by the AnLF 14. Finally, the NWDAF 10 comprises a Data Collection Coordination Function (DCCF) 20 that coordinates the collection of the data required by the ML model 16 and AnLF 14 to generate the analytics report(s).

The analytics report can include statistics relating to the network/network state, and/or predictions relating to a future state of the network (e.g. congestion may be X % in 10 minutes). Some types of analytics report that can be generated include: reports relating to congestion levels in the network; reports predicting quality QoE metrics; reports predicting mobility patterns; reports predicting or indicating slice load; etc.

As noted above, the NWDAF 10 can receive multiple requests for analytics reports from different NF consumers 12 in a similar time period (and in particular multiple requests for analytics reports from multiple instances of a same type of NF consumer). The AnLF 14 generates analytics reports in response to those requests, and these analytics reports can include respective predictions of actions to be taken by the NF consumers in response to the contents of the analytics report. It is possible that multiple ones of or all of these actions may conflict with each other, or be redundant (e.g. multiple NF consumers may perform the same action, but only one of them should do so to achieve the desired effect on the communication network). Any type of action by a NF consumer is considered herein, but for example the types of action that can be taken or performed by a NF consumer can include any of traffic engineering decisions (e.g. routing and/or configuration changes); priority settings; resource assignments and limitations; and service adaptation and admission control.

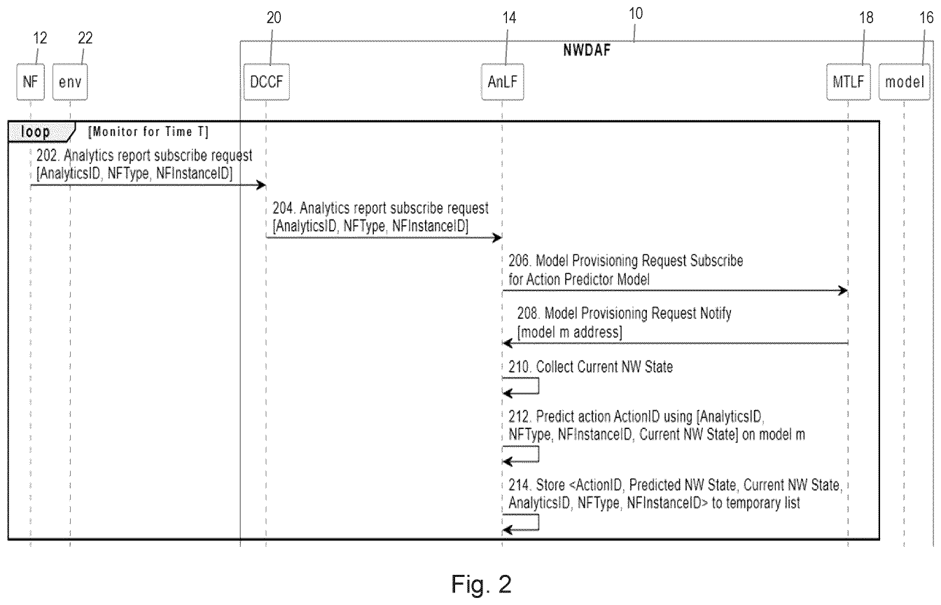

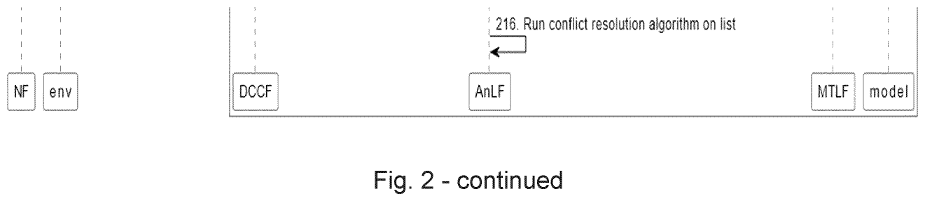

The signalling diagram in FIG. 2 illustrates an embodiment of the techniques presented herein that can improve the handling of multiple analytics reports by NWDAF 10.

FIG. 2 shows the signalling between a plurality of NF consumers 12 (which is represented in FIG. 2 by a single NF block) and a NWDAF 10 that comprises an AnLF 14, a ML model 16, a MTLF 18 and a DCCF 20. FIG. 2 also includes a representation of the environment (env) 22 from which the NWDAF 20 retrieves the network state/data. The environment 22 can include other NFs/NF consumers, an Operations Support System (OSS), an Operations & Maintenance (OAM) node, etc.

The ML model 16 has been trained to predict an action-which can be represented by an action identifier (ID)—given an analytics request (i.e. a request from a NF consumer 12 for an analytics report), as well as the next network state. The ML model 16 can be any suitable type of ML model, for example a convolutional neural network (CNN) or a recurrent neural network (RNN). The network state can be represented by a number/list of key performance indicators (KPIs) that can be vectorised and received by the AnLF 14 via a Data Collection process. Alternatively, the KPIs can be received via a Messaging Framework Adaptor Function (MFAF), from a UE, etc., as discussed in section 6.2.6.3 of 3GPP TS 23.288 v17.4.0.

The inputs to the trained ML model 16 can include any or all of the following information:
Information about the NF consumer/service consumer 12 that sent the request for the analytics report. For example the information can identify the specific NF consumer 12 that sent the request (e.g. using an “NFInstanceID”), the type of NF consumer 12 that sent the request (e.g. using “NFType”), and/or an identifier for the request itself (e.g. “AnalyticsID”);
The current network state (represented as/by a set of KPIs), which can be retrieved by the MTLF 18 using the DCCF 20 and/or a Messaging Framework Adaptor Function (MFAF) and the data collection service of the DCCF 20; and
Information on a previous effect of different actions on the network state (e.g. from a previous state to the current state).

KPIs that can represent the state of the network can include any of: KPIs relating to resource usage, e.g. bytes downloaded/uploaded, throughput and/or delay statistics; a number of sessions; resource block utilisation and channel quality metrics (e.g. reference signal received power (RSRP) and reference signal received quality (RSRQ) from the radio access network (RAN); NF load and resource usage metrics; user equipment (UE) data rates; etc. Further examples are set out in the “Input Data” sections of 3GPP TS 23.288.

The AnalyticsID can indicate the type of analytics report requested (e.g. a congestion level report), and may include or be accompanied by values of one or more parameters indicating the time period that the analytics report is to relate to, which UEs the report is to cover, which Areas of Interest (AoI) and/or network slices the report is to relate to, etc.

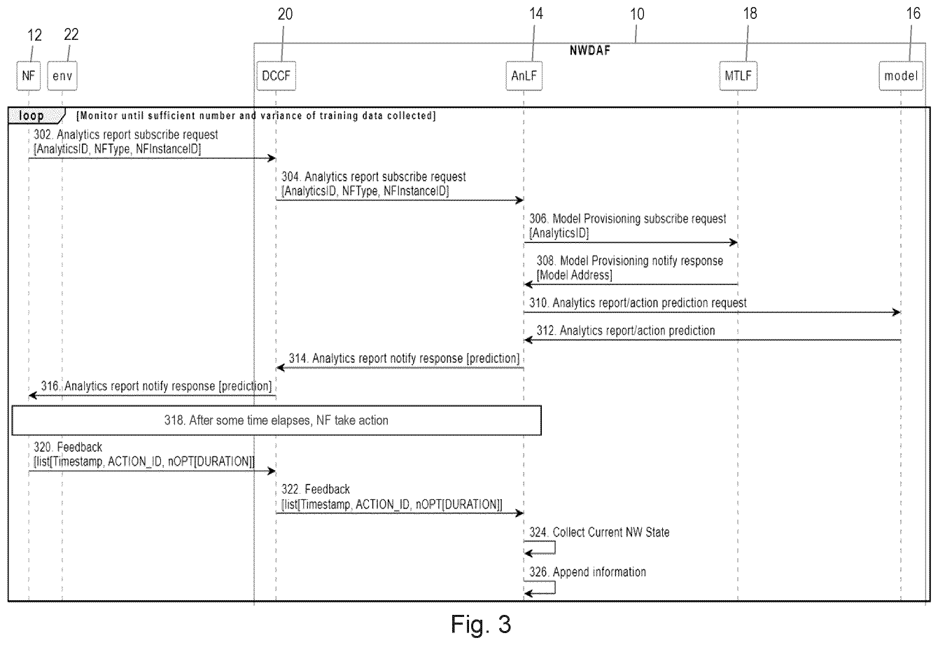

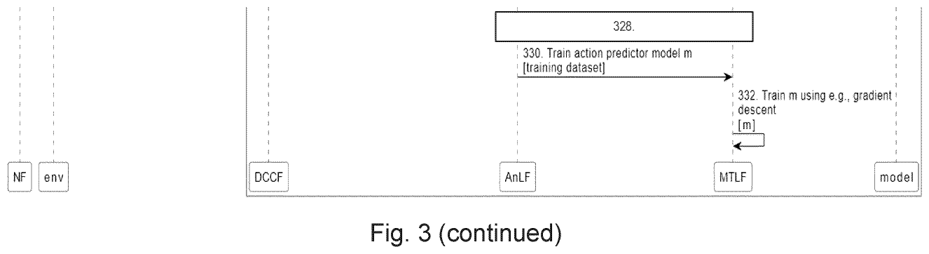

Using the input information, the ML model 16 predicts an action for the NF consumer 12 to take. The action that the NF consumer 12 is predicted to take can be represented in the form of an action identifier (“ActionID”). Further details of the action identifier are provided below. In some embodiments, the ML model 16 can generate a prediction of the state of the network if the indicated action is taken (denoted “Predicted NW State”) in FIG. 2. The model 16 may optionally be trained to provide an estimation of the time of when the NF consumer 12 is to take the action, and/or a duration/time period until the action has the required effect on the network state. The latter two outputs are optional, and the ability of the ML model 16 to predict those outputs is dependent on the training data including information about actions that have previously been performed by NF consumers 12 (for example the information indicated in Table 1 below). An exemplary training process for the ML model 16 is described below with reference to FIG. 3.

Steps/signals 202-214 in FIG. 2 take place with a time period/time window t. During this time window, the NWDAF 10 monitors incoming requests for analytic reports.

When an NF consumer 12 requires an analytics report, the NF consumer 12 sends a request for an analytics report to the NWDAF 10. This request is shown by analytics report subscribe request 202, that is received by the DCCF 20 in the NWDAF 10. The analytics report subscribe request 202 can include information relating to the specific request from the NF consumer 12. For example, the analytics report subscribe request 202 can identify the NF consumer 12 that sent the request 202 (e.g. “NFInstanceID”), the type of NF (e.g. “NFType”) that sent the request 202, and/or an identifier for the request (e.g. “AnalyticsID”).

The DCCF 20 forwards this subscribe request to the AnLF 14, as shown by signal 204. Signal 204 can comprise the information relating to the specific request that was contained in signal 202 (e.g. any of the “NFInstanceID”, the “NFType”, and “AnalyticsID”).

As a result of receiving the request 204, the AnLF 14 requests the MTLF 18 to provide a ML model 16 that can generate the analytics report, and that can generate a prediction of an action that the NF consumer 12 will take in response to the content of the analytics report. This request for model provisioning is shown as signal 206. It will be appreciated that the analytics report and the prediction can be generated by a single ML model 16, or by respective ML models 16.

The MTLF 18 sends a reply 208 to the AnLF 14 that provides the ML model 16, or that indicates a location at which the ML model 16 can be accessed by the AnLF 14. Thus, in some embodiments, the reply 208 (“model provisioning request notify”) can indicate an address for the ML model 16.

At step 210 the AnLF 14 collects information on the current network state that is required to generate the analytics report and predict the action that the NF consumer 12 will take.

At step 212 the AnLF 14 uses the ML model 16 and the collected information on the current network state to generate the analytics report and predict the action that the NF consumer 12 will take. Step 212 can also take as input the information identifying the NF consumer 12 that sent the request 202. The action that the NF consumer 12 is predicted to take can be represented in the form of the action identifier (“ActionID”). In some embodiments, the ML model(s) 16 used in step 212 can generate a prediction of the state of the network if the indicated action is taken (“Predicted NW State”).

At step 214 the AnLF 14 stores various information about the request 202 and the result of step 212 in a database or temporary list. The database/temporary list can include information for any requests 202 received during the time window t. The information about the request 202 that is stored can include the action identifier, a predicted network state resulting from the NF consumer 12 performing the identified action (“Predicted NW State”), the current network state (“Current NW State”), and/or the information about the NF consumer 12 that sent the request 202.

At the end of the time window t, the NWDAF 10 has stored results for a number of different requests 202 from a number of different NF consumers 12. As the performance of multiple ones of or all of these actions may conflict with each other, or be redundant, in step 216 the AnLF 14 (or more generally the NWDAF 10) runs a conflict resolution algorithm on the database or stored list to determine which predicted action(s) should be performed and therefore which analytics report(s) should be sent to the requesting NF consumer(s) 12.

Having determined the action that is to be performed, the AnLF 14 (or more generally the NWDAF 10) sends the corresponding analytics report with the indication of the action to be taken to the NF consumer 12 that made the request. The NF consumer 12 evaluates the content of the analytics report, and takes an action if required. It should be noted that the NF consumer 12 does not have to perform the action predicted by the NWDAF 10, and the NF consumer 12 is free to take a different, or no, action if that is determined to be the most appropriate course of action.

There are a number of different ways in which step 216 can be performed.

In a first approach, if the analytics report requests received within time window t are predicted to result in the same action by the NF consumers 12, then only one of these requests can be answered, as multiple NF consumers 12 taking actions would be redundant.

In a second approach, if the analytics report requests received within time window t are predicted to result in different actions that lead to diverse network states, then only one request would need to be selected (and responded to) over others. In one embodiment, the request to select can be determined on a ‘round-robin’ basis, e.g. after selecting a request from one NF consumer 12, a request from a different NF consumer 12 will be selected in the next time period t. Other embodiments are described below. The network state can be represented by a number/list of KPIs (e.g. the KPIs outlined above) that are vectorised and received. One of several different strategies can be used to determine which request to select:
Specificity—If all the conditions of two or more requests 202 are satisfied (i.e. they are received within the time window), the AnLF 14 can choose to respond to the request 202 that the model 16 is more confident about (i.e. the request that the model has the highest confidence is correct). That is, the model 16 can indicate a confidence level for the action predicted for that request 202, and action that is to be taken (and the corresponding analytics report sent to the relevant NF consumer 12) is the action that has the highest confidence.
Recency—When two or more requests could be chosen, the AnLF 14 can favour (select) the one that was received more recently.
Not previously used—If a request's conditions are satisfied, but previously the same request has been granted (i.e. the analytics report and predicted action sent to the NF consumer 12), the AnLF 14 can respond to another request 202 for a different type of analytics report from the same NF consumer 12 or another request 202 from a different NF consumer 12 (this is a round-robin type of approach).
Order—the AnLF 14 can select the first request 202 temporally, e.g. in a first in-first out (FIFO) manner.
Arbitrary choice—the AnLF 14 can select a random request 202 from the pool of requests to respond to. This approach has the advantage of being simple to compute.

The signalling diagram in FIG. 3 illustrates an exemplary training process by which ML model 16 can be trained to provide a prediction of an action. As with FIG. 2, FIG. 3 shows the signalling between a plurality of NF consumers 12 (which are again represented in FIG. 3 by a single NF block) and a NWDAF 10 that comprises an AnLF 14, a ML model 16, a MTLF 18 and a DCCF 20. FIG. 3 also includes the representation of the environment (env) 22.

The training process begins with the premise that the NWDAF's MTLF 18 is to train an ML model 16 (also denoted m) as set out above with respect to FIG. 2. That is, the ML model 16 is trained to predict an action-which can be represented by an action identifier (ID)-given an analytics request, as well as (optionally) the next network state. In this embodiment, the ML model 16 also generates the analytics report, but it will be appreciated that in other embodiments the action prediction and analytics report generation can be performed by different models 16.

Loop 300 in FIG. 3, which comprises signals/steps 302-326, relates to the acquisition of the training data for training or retraining the model 16. Loop 300 is performed until sufficient data has been collected to train/retrain the model 16. Signals/steps 328-332 relate to the training of the model 16 itself.

When an NF consumer 12 requires an analytics report, the NF consumer 12 sends a request for an analytics report to the NWDAF 10. This request is shown by analytics report subscribe request 302, that is received by the DCCF 20 in the NWDAF 10. The analytics report subscribe request 302 is similar to the analytics report subscribe request 202 in FIG. 2 and can include information relating to the specific request from the NF consumer 12. For example, the analytics report subscribe request 202 can identify the NF consumer 12 that sent the request 202 (e.g. “NFInstanceID”), the type of NF (e.g. “NFType”) that sent the request 202, and/or an identifier for the request (e.g. “AnalyticsID”).

The DCCF 20 forwards this subscribe request to the AnLF 14, as shown by signal 304. Signal 304 can comprise the information relating to the specific request that was contained in signal 302 (e.g. any of the “NFInstanceID”, the “NFType”, and “AnalyticsID”).

As a result of receiving the request 304, the AnLF 14 requests the MTLF 18 to provide a ML model 16 that can generate the analytics report, and (if already trained to) that can generate a prediction of an action that the NF consumer 12 will take in response to the content of the analytics report. This request for model provisioning is shown as signal 306, and this request can indicate the identifier for the request (AnalyticsID).

The MTLF 18 sends a reply 308 to the AnLF 14 that provides the ML model 16, or that indicates a location at which the ML model 16 can be accessed by the AnLF 14. Thus, in some embodiments, the reply 308 (“model provisioning notify response”) can indicate an address for the ML model 16.

If the model 16 has already been trained to provide the action prediction and Loop 300 relates to the collection of data for retraining (improving) the model 16, then the AnLF 14 sends a request 310 to the ML model 16 (according to the received address) to generate the analytics report and the action prediction. The model 16 generates the analytics report and the prediction using the appropriate input data, and sends it to the AnLF 14 (shown by signal 312). If the model 16 is not yet trained to provide an action prediction, the AnLF 14 just requests the analytics report via signal 310 and receives the generated report via signal 312.

The AnLF 14 sends the analytics report (and action prediction, if generated) to the DCCF 20 (signal 314), and the DCCF 20 forwards the analytics report (and prediction, if generated) to the relevant NF consumer 12 (signal 316). Signals 314 and 316 are labelled Analytics report notify response in FIG. 3.

After some time elapses from the NF consumer 12 receiving the analytics report, in step 318 the NF consumer 12 performs an action (which might be the action predicted by the model 16).

To provide useful training data for the ML model 16 to provide an action prediction, the NF consumer 12 provides feedback to the NWDAF 10 after taking an action in response to the received analytics report. This feedback is shown by signal 320 from the NF consumer 12 to the DCCF 20, and the forwarding of that feedback to the AnLF 14 (signal 322). The feedback in signals 320, 322 can be in the form of an action identifier, an indication of the time at which the action was taken by the NF consumer 12, and optionally also the duration or time taken for the action to have an effect (or the desired effect) on the state of the network.

In step 324 the AnLF 14 collects information on the current network state (e.g. in terms of values of one or more KPIs). This information forms part of the training data, along with the information in the feedback (320, 322) on the action taken by the NF consumer 12.

In step 326, the AnLF 14 appends further relevant information to the training data (and specifically to the action feedback), for example any of: information identifying the NF consumer 12, e.g. “NFInstanceID” and/or “NFType”; an identifier of the analytics report request that led to the analytics report and action being taken (e.g. “AnalyticsID”); and information indicating the current network state.

Once enough training data has been collected via loop 300, the MTLF 18 starts the training process. That is, in step 328 the MTLF 18 can expose a service for training the model 16 using AnLF-supplied training data. Alternatively, the AnLF 14 may have stored the training data in an Analytical Data Repository Function (ADRF) instead of storing it at the AnLF 14, and the MTLF 18 can retrieve the training data from the ADRF via the DCCF 20.

Assuming the former option, the AnLF 14 sends the training data to the MTLF 18 (as shown by signal 330).

At step 332, the MTLF 18 trains the ML model 16 using the training data. Various different training techniques can be used to train the ML model 16, for example depending on the type of technology used for the ML model 16. In some embodiments, a gradient descent training technique can be used. Other training techniques that can be used include Stochastic Gradient Descent (SGD), Limited-memory Broyden-Fletcher-Goldfarb-Shanno (L-BFGS) for classification models, and non-linear conjugate gradient for regression models.

The result of step 332 is a ML model 16 that is able to predict an action to be taken by a NF consumer 12 in response to an analytics report, given a current network state. This trained model 16 is deployed for use by the NWDAF 10, for example according to the method shown in FIG. 2.

It will be appreciated that over time the ML model 16 may need to be retrained in order for the action predictions to remain sufficiently accurate. That is, the numbers and/or types of NF consumers in a communication network is not fixed, and instances of NF consumers can be activated or deactivated over time. This can mean that the NF consumer environment is quite dynamic, and retraining is required to enable predictions to be made for newly-joined NF consumers, or for new types of action that the ML model 16 had not previously encountered.

As noted above, the ML model 16 provides a prediction of an action to be taken by an NF consumer 12, and a NF consumer 12 can be required to provide feedback indicating an action that has been taken. In both cases, the action to be taken is to be identified in some form, and this identifier for the action is referred to as an action identifier or ActionID.

In some embodiments, a set of action identifiers can be defined for a set of actions, with the NWDAF 10 and NF consumers 12 both knowing the mapping between action identifiers and actions, and both the NWDAF 10 and NF consumers 12 ‘semantically understanding’ what those actions are. In other words, while the NWDAF 10 does not, and is not able to, take the actions itself, the NWDAF 10 understands what those actions are from the respective action identifier, and what effect those actions have on the network state.

While the above approach enables the NWDAF 10 to train the ML model 16 to predict actions to be taken and that can identify those actions using action identifiers that are understood by the NF consumers 12, the above approach is not preferred as it requires the NWDAF 10 to be aware of all possible types of actions by all possible types of NF, and this may change over time, requiring the NWDAF 10 to be updated, and the relevant action identifiers coordinated with all of the NF consumers 12.

Thus, in preferred embodiments, an action identifier is used that is not ‘understood’ by the NWDAF 10, but instead action identifiers unique to individual NF consumers 12 are used consistently by those NF consumers to indicate when a particular action has been performed.

For example, one instance of a Policy Control Function (PCF_A) may perform a first type of action to change the scheduling of user traffic, and can identify this action to the NWDAF using a particular action identifier, e.g. “ActionID A7”. When PCF_A subsequently performs that same type of action, PCF_A again provides ActionID A7 to the NWDAF to indicate that PCF_A took the same type of action as before. If PCF_A performs a different type of action, a different action identifier (e.g. “ActionID A4”) is signalled to the NWDAF. In this way, the NWDAF will know when PCF_A has performed the same type of action, but won't know exactly what that action is. When another instance of a PCF, PCF_B, performs the first type of action to change the scheduling of user traffic, PCF_B sends its own action identifier for that action to the NWDAF. In this case, PCF_B can send an action identifier, e.g. “ActionID B2”, to the NWDAF, and PCF_B will send this action identifier any time that it performs the first type of action.

Thus, in these embodiments, an action identifier is used which is unique to every action taken by a NF, but does not necessarily convey the semantics of the action, which in any case are unknown to the NWDAF. The purpose of the action identifier is to differentiate between different actions taken by NFs, and the action identifier can be as simple as an integer. A NF consumer can also provide a timestamp indicating the point in time when the action took place, as well as an estimation of how long the impact of the action will exist in the network, which is also known as an action's lifetime.

For the NWDAF 10 to be able to train the ML model 16 to predict an action and provide an action identifier that is understandable by the NF consumer 12 that requested the analytics report, the NWDAF 10 requires training data that includes the unique action identifiers from the different NF consumers 12. This training data can be collected as described above with respect to FIG. 3 (i.e. the NWDAF 10 receive action identifiers in feedback 320). More generally, even when NWDAF 10 is not specifically collecting data for training/retraining the ML model 16, NF consumers 12 can send feedback to the NWDAF indicating the action that they have just performed.

Thus, embodiments of this disclosure use a feedback signal from a NF consumer to the NWDAF (or other type of analytics node), which consists of an action identifier (e.g. action ID), a timestamp of the action, and optionally, the action's lifetime (i.e. how long the impact of the action will exist in the network). Each action type is associated with a unique ID (the ActionID) and differs depending on the nature (type) of the NF consumer. Thus, even if the NWDAF 10 does not know anything about the internal workings of the NF taking the action, and the NWDAF 10 does not understand what the actions taken will imply for the network, and therefore for its prediction, the NWDAF 10 can still learn the effects of this action on monitored key performance indicators (KPIs), simply by differentiating it from other actions.

The action ID/action type is useful as, for example, an Access and Mobility Management Function (AMF) may take different actions to a PCF. This unique identifier can be, for example, an integer that logically corresponds to an action. As noted, the action type does not necessarily need to specify all the semantics of the action, as these semantics will be unknown to NWDAF anyway. For example, considering the PCF, instead of “update Policy and Charging Control (PCC) rule at PCF with Quality of Service (QoS) Class Identifier (QCI) Y and Service Description Filter (SDF) X”, the action type could simply be an integer, e.g., 1.

Alternatively an action can be identified by an identifier of a type of NF (NFType) that is taking or initiating the action, and an integer. The NFType and action ID can be represented in combination, e.g., “AMF.1”, or “PCF.13”. The NFType parameter-which indicates the type of network function is described in 3GPP TS 29.510 v18.0.0 (2022-09) “Technical Specification Group Core Network and Terminals; 5G System; Network Function Repository Services; Stage 3 (Release 18)” (referred to herein as Reference 2).

As another alternative, an action can be identified by the NFType, the vendor (i.e. the entity that manufactured or provided the NF), the software revision number, and an integer, e.g., AMF.VendorA.v13,4.13.

The timestamp of the action can indicate the moment in time (and date) when the action took place. Different formats can be used, for example the date-time formats specified in “STANDARD FOR THE FORMAT OF ARPA INTERNET TEXT MESSAGES” by Crocker, D., STD 11, RFC 822, DOI 10.17487/RFC0822, August 1982, https://www.rfc-editor.org/info/rfc822 (referred to herein as Reference 3), or a UNIXTIME, or other suitable date-time format. Optionally, information may be included in the feedback message to provide an assessment on behalf of the NF consumer for when the action has taken effect. For example, when a PCF creates a new policy and charging control (PCC) rule, the PCF may receive an asynchronous response for when this rule was created and when it has taken effect. Subtracting this time from the time that the action took place can give an indication of the effect of the action. Therefore, the timestamp for action creation can optionally have a duration indicator, which indicates the NF assessment of the time for an action to take effect.

Table 1 below summarises the parameters that can be included in the payload of the feedback.

TABLE 1

| Parameter | | Manda- | Cardi- |
|---|---|---|---|
| Name | Description | tory | nality |
| Timestamp | A timestamp indicating when an action | YES | 1 . . . N |
| | took place by the Service Consumer | | |
| | (NF) | | |
| Action_ID | A unique identifier of an action | YES | 1 . . . N |
| Lifetime | The estimated duration of an action | NO | 1 . . . N |
| | from the service consumer | | |

The feedback signal can be sent asynchronously from the NF consumer in response to an analytics report and/or action prediction, upon the NF consumer taking an action. From the time between an analytics report being delivered to a NF consumer 12 by the NWDAF 10 and the feedback being sent back to the NWDAF 10, there exists a period that allows the NF consumer 12 to act and potentially observe the time that the action takes effect. In this case the optional “duration” parameter can be used.

While the above embodiments describe that the action feedback from the NF consumers 12 provides the training data for training the ML model 16 to generate action predictions, further embodiments described below make use of this action feedback to evaluate the accuracy of the analytics report, or the accuracy of the ML model that generates the analytics report.

In particular, it is important for the NWDAF 10 to be able to measure the accuracy of the ML models that are in use. One way to do this is to collect information about network parameters as a ground truth which can be used to verify the accuracy/correctness of the predictions that have previously been generated. However, in some cases, there might be actions, taken by the NF consumer 12 upon receiving some analytics from the NWDAF 10, that could affect the prediction. In those cases, the collected data can be misleading for the NWDAF 10 as it may provide false information about the validity of the prediction.

For example, the PCF may request the NWDAF to predict potential future congestion. If the NWDAF predicts that there will be a congestion, the PCF can perform remedies such as preventive actions to avoid the congestion. Later, the NWDAF can collect information and observe that no congestion has occurred, which will lead the NWDAF to the conclusion that the prediction of congestion was incorrect, while in fact the prediction of congestion was correct. In this case, the congestion didn't occur due to the action(s) taken by the PCF (service consumer) and the NWDAF didn't have a complete picture of the system with information about possible actions to evaluate the prediction results precisely. In such a scenario, a service consumer providing feedback about the actions taken would be useful for the NWDAF to verify the accuracy/correctness of the prediction.

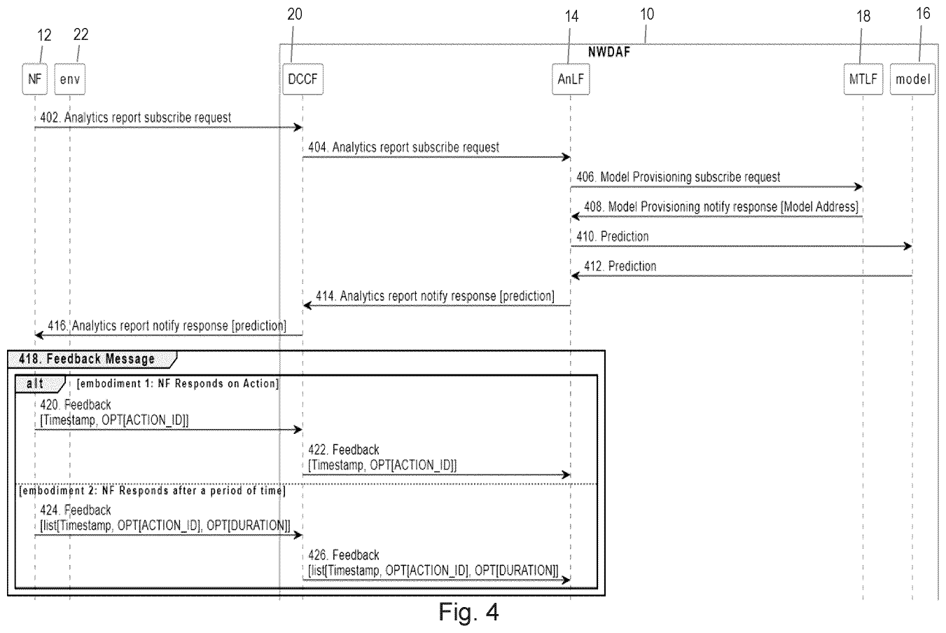

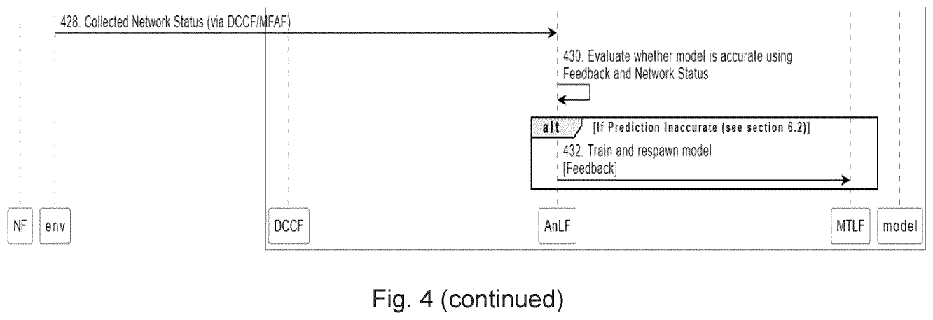

FIG. 4 is a signalling diagram illustrating a NF consumer 12 sending a feedback signal to a NWDAF 10 for use in assessing the accuracy of a ML model 16 used to generate an analytics report (and optionally also the action prediction), along with other signalling between the NF consumer 12 and NWDAF 10. As in FIGS. 2 and 3, NWDAF 10 comprises AnLF 14, MTLF 18 and DCCF 20.

Briefly, as FIG. 4 illustrates, the process at the AnLF 14 of the NWDAF 10 for generating an analytics report in a response to a request from a NF consumer 12 is independent of the feedback message. In fact, the feedback message is sent as information by the NF consumer 12, after the analytics response prediction (analytics report) is sent to the NF consumer 12. In some embodiments, the feedback is provided as soon as the NF consumer 12 takes an action, while in another case, feedback is delayed, e.g., it is provided after a period that can either be set by design (i.e. predetermined), or decided by the NF consumer 12. In the latter case, an upper time constraint can be set by which the NF consumer 12 would have to provide feedback. In case feedback is delayed, the NF consumer 12 can optionally provide an assessment of the duration of when an action has taken effect from the NF's perspective. This can be, for example, the duration between the NF consumer 12 acting and the NF consumer 12 receiving a synchronous or asynchronous response, from the node or nodes that were recipients of this action. Also, in case of delayed feedback, there is an option that the NF consumer 12 takes multiple actions, e.g., configures multiple PCC rules in the case of the NF consumer 12 being a PCF. In either embodiment, the NF consumer 12 can provide the action identifier or action identifiers of the action(s) it took in response to the data report of the NWDAF 10. This information can all be encapsulated in the feedback message that is sent to the AnLF 14.

The AnLF 14 can then evaluate whether the ML model 16 supplied by the MTLF 18 made an accurate prediction (i.e. an accurate analytics report and/or accurate action prediction). In its evaluation of whether the model 16 made an accurate prediction, in addition to the network state, the AnLF 14 can also use the feedback from the NF consumer 12 to determine whether the prediction was correct or not.

In FIG. 4, when NF consumer 12 requires an analytics report, the NF consumer 12 sends a request for an analytics report to the NWDAF 10. This request is shown by Analytics report subscribe request 402, that is received by the DCCF 20 in the NWDAF 10. The analytics report subscribe request 402 is similar to the analytics report subscribe request 202 in FIG. 2 and can include information relating to the specific request from the NF consumer 12. For example, the analytics report subscribe request 402 can identify the NF consumer 12 that sent the request 402 (e.g. “NFInstanceID”), the type of NF (e.g. “NFType”) that sent the request 402, and/or an identifier for the request (e.g. “AnalyticsID”).

The DCCF 20 forwards this subscribe request to the AnLF 14, as shown by signal 404. Signal 404 can comprise the information relating to the specific request that was contained in signal 302 (e.g. any of the “NFInstanceID”, the “NFType”, and “AnalyticsID”).

As a result of receiving the request 404, the AnLF 14 requests the MTLF 18 to provide a ML model 16 that can generate the analytics report and/or action prediction. This request for model provisioning is shown as signal 406 (labelled “Model Provisioning subscribe request”).

The MTLF 18 sends a reply 408 to the AnLF 14 that provides the ML model 16, or that indicates a location at which the ML model 16 can be accessed by the AnLF 14. Thus, in some embodiments, the reply 408 (“Model provisioning notify response”) can indicate an address for the ML model 16.

The AnLF 14 sends a request 410 to the ML model 16 to generate the analytics report (and optionally also the action prediction). The model 16 generates the analytics report and the prediction (if required) and sends it to the AnLF 14 (shown by signal 412). If the model 16 is not trained to provide an action prediction, the AnLF 14 just requests the analytics report via signal 410 and receives the generated report via signal 412.

The AnLF 14 sends the analytics report (and action prediction, if generated) to the DCCF 20 (signal 414), and the DCCF 20 forwards the analytics report (and prediction, if generated) to the relevant NF consumer 12 (signal 416). Signals 414 and 416 are labelled Analytics report notify response in FIG. 4.

After some time elapses from the NF consumer 12 receiving the analytics report, the NF consumer 12 performs an action (which might be the action predicted by the model 16). Block 418 illustrates two embodiments for providing the feedback message indicating the feedback on the action taken by the NF consumer 12. Signals 420 and 422 relate to a first embodiment of the feedback message, and signals 424 and 426 relate to a second embodiment of the feedback message.

In the first embodiment the NF consumer 12 sends the feedback indicating the action taken when (i.e. at the time) the action is taken. Thus, the NF consumer 12 sends a feedback message 420 to the NWDAF 10/DCCF 20, and the DCCF 20 forwards the feedback message to the AnLF 14 (signal 422). The feedback message contains the action identifier (ActionID) and a timestamp indicating the time at which the action was taken.

In the second embodiment the NF consumer 12 sends the feedback indicating the action taken some time after the action was taken. In this case, the feedback message can indicate a plurality of actions that have been taken by the NF consumer 12 since the last feedback message was sent. Thus, the NF consumer 12 sends a feedback message 424 to the NWDAF 10/DCCF 20, and the DCCF 20 forwards the feedback message to the AnLF 14 (signal 426). The feedback message contains a list comprising one or more entries, with each entry relating to a respective action taken by the NF consumer 12. Each entry comprises an action identifier (ActionID), a timestamp indicating the time at which the action was taken, and optionally the duration (the time taken for the action to have an effect on the network state).

Separate to the feedback message(s), over time the AnLF 14 collects information on the changing network state. This is indicated by signal 428 from the environment 22 to the AnLF 14.

In step 430, the AnLF 14 evaluates whether the model 16 is accurate. This evaluation makes use of the collected network state information and the content of the feedback messages indicating the actions (and timing) taken by the NF consumers 12.

If it is determined in step 430 that the model 16 is inaccurate (or not sufficiently accurate), the AnLF 14 sends a signal 432 to the MTLF 18 requesting that the MTLF 18 train or retrain the model 16.

The following sets out an exemplary technique for performing step 430 to evaluate the accuracy of the model 16.

Initially, let NW_State[t] be the observed network state from the environment 22 at time t. Such network state can be observed from an operation and maintenance (OAM) node and other NFs by the NWDAF 10. The NW_State depends on the identifier of the request for the analytics report (“AnalyticsID”). It is assumed that the NWDAF 10 knows what KPIs to monitor in order to deduce or determine that network state. For example, this can be done by NWDAF 10 storing the state historically for an AnalyticsID. Then, when a feedback message is received indicating an action that has been taken, the NWDAF 10 can compare the current network state with the predicted network state (with prediction[t] denoting the predicted network state). “Feedback” denotes the action feedback provided by the NF consumer 12 and received/retrieved by the AnLF 14. “THRESHOLD” denotes the maximum acceptable difference between the predicted network state and the observed network state.

```
  Then, if:
    distance(NW_State[t], prediction[t]) > THRESHOLD
and Feedback indicates at least one action has been taken, where the timestamp of that action is earlier than
t, then the model 16 can be considered as accurate, and retraining at the MTLF 18 is not required.
  Else, if:
    distance(NW_State[t], prediction[t]) > THRESHOLD
and there is Feedback indicates that no action was taken (or there is no Feedback), then retraining of the model
16 at the MTLF 18 can be triggered.
  Else if:
    distance(NW_State[t], prediction[t]) <= THRESHOLD
then the model 16 can be considered as accurate, and retraining at the MTLF 18 is not required.
```

There can be several variations of the above algorithm, for example, based on the identified action (as some identifiers tend to impact network state more than others) as well as the projected duration between the action taking place and the action actually taking effect.

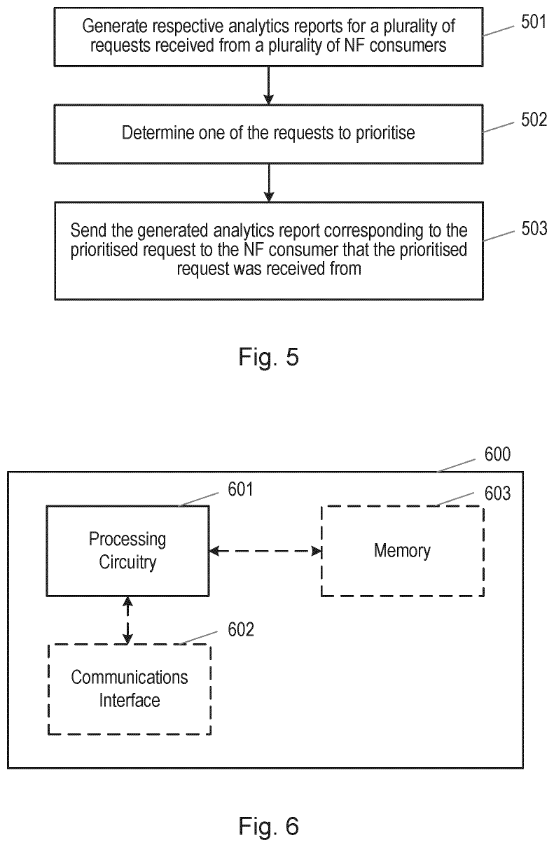

FIG. 5 is a flow chart illustrating a method according to various embodiments performed by a network node in a communication network. The network node may be an analytics node for providing analytics reports relating to the communication network, such as a NWDAF 10. The network node may be one or more of the logical functions of a NWDAF 10, such as an AnLF 14 and/or MTLF 18. The network node may perform the method in response to executing suitably formulated computer readable code. The computer readable code may be embodied or stored on a computer readable medium, such as a memory chip, optical disc, or other storage medium. The computer readable medium may be part of a computer program product.

In step 501 the network node generates, using a first trained model, respective analytics reports for a plurality of requests received from a plurality of NF consumers 12. Each generated analytics report comprises an indication of an action that the respective NF consumer is predicted to take in response to evaluating the respective analytics report. For example, an analytics report may contain a prediction that there will be congestion in the network in 5 minutes, and the NWDAF can predict that, in response to this congestion prediction, the PCF will take an action to reduce QoS, e.g. by relaxing latency requirements, reducing or removing a guaranteed bitrate, relaxing a packet drop percentage requirement, etc. When the PCF receives the analytics report and evaluates the congestion prediction contained therein, the PCF can decide to reduce the QoS to mitigate the congestion (for example in one or more of the ways set out above). The indication of the action may be an action identifier, for example in the form of an integer or value. In some embodiments, the network node does not know the mapping between action identifiers and specific types of action taken by the NF consumer is not known to the network node. Step 501 generally corresponds to step 212 in FIG. 2.

The prediction of the action may be generated by the first trained model (i.e. the same model that generates the analytics report), or it can be generated by a second, separate, trained model.

The prediction of the action can be generated using information such as an identity and/or type of NF consumer that made the request, a type of analytics report requested, a current state of the communication network, and/or a previous effect of the action on the communication network.

In some cases, step 501 may result in the plurality of generated analytics reports indicating that the respective NF consumers are to perform the same type of action. In other cases, step 501 may result in the plurality of generated analytics reports indicating that the respective NF consumers are to perform different types of action, but these different actions would result in diverse (conflicting) states for the communication network.

Thus, in step 502, the network node selects one of the requests.

In some embodiments of step 502, the request is selected based on the respective actions predicted for the NF consumers. In some embodiments, step 502 can comprise one of: selecting a request at random; selecting the request that was received by the network node first; selecting the request that was received by the network node most recently; selecting the request with a predicted action having a highest confidence value; and selecting a request received from a NF consumer that has not previously had a request selected.

Step 502 generally corresponds to step 216 in FIG. 2.

In step 503, the network node sends the generated analytics report corresponding to the selected request to the NF consumer that the selected request was received from. The analytics reports generated in response to the other requests are not sent to the respective NF consumers that made the request.

In some embodiments, the analytics reports generated in step 501 may additionally comprise one or more of: a prediction of the state of the communication network as a result of the respective predicted action; an estimate of when the predicted action is to be taken; and an estimate of a duration for the predicted action to take effect in the communication network.

In some embodiments, the method can comprise further steps that enable an accuracy of the first trained model to be evaluated. In particular, the network node can receive a feedback message from the NF consumer to which the generated analytics report was sent in step 503 (e.g. as described above with reference to the feedback message in block 418 of FIG. 4). The feedback message comprises an action identifier for an action taken by the NF consumer in response to the analytics report. The feedback message can optionally also include a timestamp indicating a time at which the action was taken by the NF consumer, and/or a duration indication that indicates an estimate of an amount of time from the action being performed to a time at which the action has an effect on the communication network. A mapping between action identifiers and types of action used by the NF consumer is not known to the network node, although the network node considers actions having a same action identifier to be a same type of action. In these embodiments, the action identifier can comprises one or more of: an integer or value used to indicate the type of action; a type of NF consumer that performed the action; a vendor of the NF consumer; and a software revision number of the NF consumer.

The network node receives information on a status of the communication network following the taking of the action (e.g. as shown by signal 428 in FIG. 4). The information on the status of the communication network can comprise measurements or values of one or more KPIs, or measurements of changes in one or more KPIs.

The network node then evaluates an accuracy of the trained first model using the action identifier and the received information. This evaluation generally corresponds to step 430 in FIG. 4. In some embodiments, the accuracy evaluation is performed by comparing a prediction of an effect of the action on the communication network to an actual effect of the action determined from the information on the status of the communication network.

If the trained first model is evaluated to be inaccurate, the first model is retrained using the action identifier and the received information. This retraining generally corresponds to step 432. In some embodiments, retraining the first model comprises using a plurality of action identifiers of one or more types of action taken by a plurality of NF consumers, and information on a status of the communication network following the taking of the respective actions.

FIG. 6 is a simplified block diagram of a network node 600 according to some embodiments that can be used to implement one or more of the techniques described herein. The network node 600 can be a NF, an analytics node or function, such as a NWDAF, or one or more logical functions that form part of an analytics node, such as an AnLF, a MTLF, or DCCF.

The network node 600 comprises processing circuitry (or logic) 601. It will be appreciated that the network node 600 may comprise one or more virtual machines running different software and/or processes. The network node 600 may therefore comprise, or be implemented in or as one or more servers, switches and/or storage devices and/or may comprise cloud computing infrastructure that runs the software and/or processes.

The processing circuitry 601 controls the operation of the network node 600 to implement the relevant part of the methods described herein. The processing circuitry 601 can comprise one or more processors, processing units, multi-core processors or modules that are configured or programmed to control the network node 600 in the manner described herein. In particular implementations, the processing circuitry 601 can comprise a plurality of software and/or hardware modules that are each configured to perform, or are for performing, individual or multiple steps of the method described herein in relation to the network node 600.

The network node 600 also comprises a communications interface 602. The communications interface 602 is for use in enabling communications with other network node, computers, servers, etc. For example, the communications interface 602 can be configured to transmit to and/or receive from other network nodes requests, acknowledgements, information, data, signals, or similar. The communications interface 602 can use any suitable communication technology.

The processing circuitry 601 may be configured to control the communications interface 602 to transmit to and/or receive from other network nodes, etc. requests, acknowledgements, information, data, signals, or similar, according to the methods described herein.

The network node 600 may comprise a memory 603. In some embodiments, the memory 603 can be configured to store program code that can be executed by the processing circuitry 601 to perform the method described herein in relation to the network node 600. Alternatively or in addition, the memory 603 can be configured to store any requests, acknowledgements, information, data, signals, or similar that are described herein. The processing circuitry 601 may be configured to control the memory 603 to store such information therein.

Although the network node may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

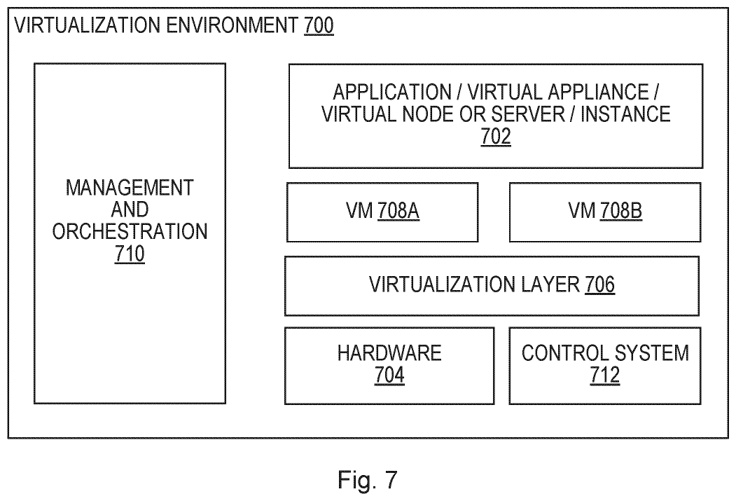

FIG. 7 is a block diagram illustrating a virtualization environment 700 in which functions implemented by some embodiments may be virtualized. The virtualization environment 700 can implement the functions of any of a NF, an analytics node or function, such as a NWDAF, or one or more logical functions that form part of an analytics node, such as an AnLF, a MTLF, or DCCF.

In the present context, virtualizing means creating virtual versions of network nodes which may include virtualizing hardware platforms, storage devices and networking resources. As used herein, virtualization can be applied to any network node described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node. Further, the network node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or Customer Premise Equipment (CPE)) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 712 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method performed by a network node in a communication network, the method comprising:
generating, using a first trained model, respective analytics reports for a plurality of requests received from a plurality of network function, NF, consumers, wherein each generated analytics report comprises an indication of an action that the respective NF consumer is predicted to take in response to evaluating the respective analytics report;
selecting one of the requests; and
sending the generated analytics report corresponding to the selected request to the NF consumer that the selected request was received from.

2. The method as claimed in claim 1, wherein the indication of the action comprises an action identifier.

3. The method as claimed in claim 2, wherein a mapping between action identifiers and specific types of action taken by the NF consumer is not known to the network node.

4. The method as claimed in claim 1, wherein the indication of the action comprises an integer or value.

5. The method as claimed in claim 1, wherein the generated analytics reports further comprise one or more of (i) a prediction of a state of the communication network as a result of the respective predicted action; (ii) an estimate of when the predicted action is to be taken; and (iii) an estimate of a duration for the predicted action to take effect in the communication network.

6. The method as claimed in claim 1, wherein the plurality of generated analytics reports comprise an indication of a same type of action for the respective NF consumers to take.

7. The method as claimed in claim 1, wherein the plurality of generated analytics reports comprise indications of different types of action for the respective NF consumers to take and that would result in diverse states for the communication network.

8. The method as claimed in claim 6, wherein the step of selecting one of the requests comprises one of:
(i) selecting the request at random;
(ii) selecting the request that was received by the network node first;
(iii) selecting the request that was received by the network node most recently;
(iv) selecting the request with a predicted action having a highest confidence value; and
(v) selecting a request received from a NF consumer) that has not previously had a request selected.

9. The method as claimed in claim 1, wherein a second trained model generates the indication of the action that the respective NF consumer is predicted to take in response to evaluating the respective analytics report.

10. The method as claimed in claim 9, wherein the second trained model generates the indication of the action based on an identity and/or type of NF consumer that made the request, a type of analytics report requested, a current state of the communication network, and/or a previous effect of the action on the communication network.

11. The method as claimed in claim 1, wherein the method further comprises:
receiving a feedback message from the NF consumer to which the generated analytics report was sent, the feedback message comprising an action identifier for an action taken by the NF consumer in response to the analytics report, wherein a mapping between action identifiers and types of action used by the NF consumer is not known to the network node, and wherein the network node considers actions having a same action identifier to be a same type of action;
receiving information on a status of the communication network following the taking of the action;
evaluating an accuracy of the trained first model using the action identifier and the received information; and
if the trained first model is evaluated to be inaccurate, retraining the trained first model using the action identifier and the received information.

12. The method as claimed in claim 11, wherein the action identifier comprises one or more of: an integer or value used to indicate the type of action; a type of NF consumer that performed the action; a vendor of the NF consumer; and a software revision number of the NF consumer.

13. The method as claimed in claim 11, wherein the feedback message further comprises a timestamp indicating a time at which the action was taken by the NF consumer.

14. The method as claimed in claim 11, wherein the feedback message further comprises a duration indication that indicates an estimate of an amount of time from the action being performed to a time at which the action has an effect on the communication network.

15. The method as claimed in claim 11, wherein the information on the status of the communication network comprises measurements of one or more key performance indicators, KPIs, or measurements of changes in one or more KPIs.

16. The method as claimed in claim 11, wherein the step of evaluating comprises comparing a prediction of an effect of the action indicated by the action identifier on the communication network to an actual effect of the action indicated by the action identifier determined from the received information on the status of the communication network.

17. The method as claimed in claim 11, wherein the step of retraining comprises retraining the first model using a plurality of action identifiers of one or more types of action taken by a plurality of NF consumers, and information on a status of the communication network following the taking of the respective action.

18. A computer program product comprising a non-transitory computer readable medium having computer readable code embodied therein, the computer readable code being configured such that, on execution by a suitable computer or processing circuitry, the computer or processing circuitry is caused to perform the method of claim 1.

19. A network node for use in a communication network, the network node configured to:
generate, using a first trained model, respective analytics reports for a plurality of requests received from a plurality of network function, NF, consumers), wherein each generated analytics report comprises an indication of an action that the respective NF consumer is predicted to take in response to evaluating the respective analytics report;
select one of the requests; and
send the generated analytics report corresponding to the selected request to the NF consumer that the selected request was received from.

20.-35. (canceled)

36. A network node for use in a communication network, the network node comprising processing circuitry and a memory, said memory containing instructions executable by said processing circuitry whereby said network node is operative to:
generate, using a first trained model, respective analytics reports for a plurality of requests received from a plurality of network function, NF, consumers, wherein each generated analytics report comprises an indication of an action that the respective NF consumer is predicted to take in response to evaluating the respective analytics report;
select one of the requests; and
send the generated analytics report corresponding to the selected request to the NF consumer that the selected request was received from.

37.-52. (canceled)
